(19) United States
(12) Patent Application Publication
(10) Pub. No.: US 2009/0327581 A1
(43) Pub. Date: Dec. 31, 2009

(54) NAND MEMORY

(76) Inventor: Richard L. Coulson, Portland, OR (US)

Correspondence Address: SCHWEGMAN, LUNDBERG & WOESSNER, P.A., P.O. BOX 2938, MINNEAPOLIS, MN, 55402, US

(21) Appl. No.: 12/165,319

(22) Filed: Jun. 30, 2008

(51) Int. Cl. G06F 12/02

(52) U.S. Cl. 711/103; 711/E12.008

(57) ABSTRACT

Disclosed herein is a method and apparatus to refresh/rewrite the data in a NAND solid state storage device (“SSD”) only when it needs to be re-written. Upon power-up, the SSD assumes that it may have been a long time since some of its data was last written, and a background task to scan through all the data is started in the SSD. During idle periods, the entire contents of the drive is read. If a location is read and it has more than “bit error threshold” bits (for example three (3) bits if there is capability to correct eight (8) bits) in error before error correction is applied, it is assumed that this memory location is retaining the data only marginally, and the corrected data should be re-written to a new location, or alternatively re-written in the same location. The corrected data is then re-written to a new location or the same location.

### TECHNICAL FIELD

This invention relates generally to memory devices, and more particularly to solid state memory devices.

### BACKGROUND

Flash memory is non-volatile computer memory that can be electrically erased and reprogrammed. In addition, flash memory offers fast read access times and better kinetic shock resistance than hard disks. These and other characteristics explain the popularity of flash memory in today's portable devices. One well known type of flash memory is NAND flash. NAND flash uses tunnel injection for writing and tunnel release for erasing, and forms the core of many memory card formats available today.

A potential limitation with the use of NAND technology for data storage is that the ability to retain data may go down with usage. After a large number of program erase cycles, data retention can be significantly lower than initial operation. One reason for this is that as storage cells experience more write/erase cycles, they are more prone to gradual charge loss. Generally, a Solid State Disk (“SSD”) in a computing system can handle lower retention because, when it is in use, data will naturally be re-written by the computing system's operating system (“OS”), and the data that is not re-written by the OS over time is often written to a new location through load leveling algorithms. Therefore, if the computer is on and the SSD is being used, the times between a NAND location being re-written is fairly short, and shorter data retention is not a concern. However, there are cases where the SSD may be left unused for a period of time much longer than normal, in which case shorter retention times may lead to the possibility of data loss.

### BRIEF DESCRIPTION OF THE DRAWING

FIG. 1 illustrates a method for refreshing memory, according to one example embodiment of the inventive subject matter.

FIG. 2 illustrates a memory device, according one example embodiment of the inventive subject matter.

FIG. 3 illustrates an electronic system, according to one example embodiment of the inventive subject matter.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, does not limit other embodiments of the invention or the invention as a whole, and any reference to the invention, its elements, operation, and application do not limit the invention as a whole but only serves to define these example embodiments. The following detailed description does not, therefore, limit the scope of the invention, which is defined only by the appended claims.

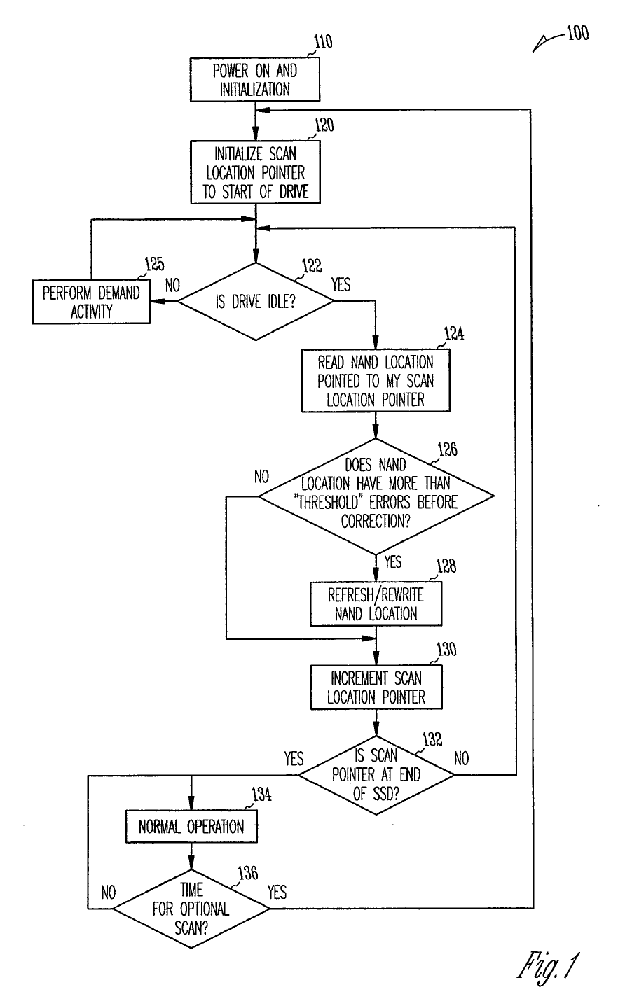

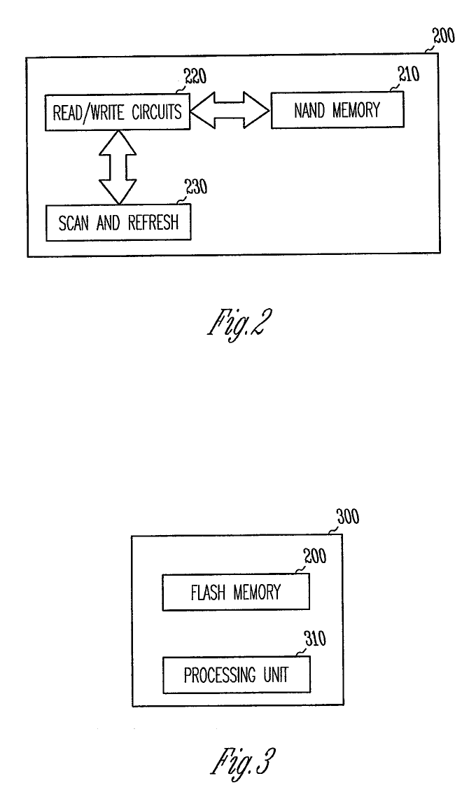

According to one example embodiment 100 illustrated in FIGS. 1 and 2, there is provided method and apparatus to refresh/rewrite the data in a NAND SSD drive only when it needs to be re-written, without any concept of time since the last re-write, and without consuming excessive power. Upon power-up and initialization 110, the SSD assumes that it may have been a long time since some of its data was last written. A scan location pointer is set 120 to the memory location at the start of the drive, and a background task to scan through all the data is started in the SSD. If the drive is not idle, the normal functions of the memory, including read/write operations, are performed 125. If the drive is idle 122, the NAND memory location pointed to by the scan location pointer is read 124. If 126 the memory location has more than a certain threshold number of error bits, the location is refreshed 128 by rewriting it with the bits error corrected in the same location, or by moving it to another location. If there are no bits in error, the refresh process is skipped. Next, the scan location pointer is incremented 130. If 132 the scan pointer is not yet at the end of the SSD, the loop from 122 to 130 is repeated. Once the scan is at the end of the SSD, the drive assumes normal operation 134. Optionally 136, the drive may be scanned again prior to the next power on and initialization. Accordingly, the time used to refresh the memory during idle periods may be interleaved with the time the memory is active to store and retrieve data.

According to one embodiment, the number of threshold error bits used to trigger re-write of data stored in a location is chosen such that the number indicates that the memory location is retaining the data only marginally. According to one example, if there is capability to correct eight (8) bits in error using error correction information stored along with the data, the threshold number of error bits used to trigger a re-write may be set to any number of bits equal to or less than eight (8), such as for example three (3) bits. The lower the threshold is set, the better the chances that any faltering memory locations are re-written before it is too late to correct the data using error correction. Thus, the example method and operation detects memory locations that have not been written for a long time and are losing charge and therefore are towards the end of their data retention capability. The locations that are starting to have bits in error, for example a higher bit error rate due to being towards the end of their data retention capability, will be freshly rewritten, starting a new data retention period. Only those locations that need rewriting are rewritten, thus not wasting write cycles when there is no reason to rewrite the data. Note that there are other reasons why a memory location would have more than “threshold” errors—it is not only because of charge loss, but a refresh/rewrite is still the appropriate action.

According to one embodiment, re-writing a memory location may include reading all pages in the NAND erase block, erasing the erase block, and re-writing all the pages in the erase block. In yet another example embodiment, the refresh operation is performed by re-writing the data in the same location but without an intervening erase function prior to the re-writing of the data in the same location. According to still another example embodiment, memory locations that require refreshing may be relocated rather than re-written in place. According to other example embodiments, the refresh operations may be implemented in firmware, software or hardware, or any combination thereof.

According to one example embodiment, the scan is performed once at power up. According to another example embodiment, the scan may be performed again after some amount of elapsed time following power up. According, to another alternative embodiment, continuous scanning may be performed, but may not be preferable due to considerations of power consumption.

According to still another optional embodiment, if more than a threshold number of memory locations have in excess of the “threshold” bits in error, it may be assumed that the drive has been off for a longer period of time and that the entire drive needs to be refreshed, and in particular even those locations that do not show excessive bit errors, as even though they might not have errors they still may have lost some charge.

Referring now to FIG. 2, there is illustrated a flash NAND device 200 that includes NAND memory 210, a read/write circuit 220, and a scan and refresh circuit 230. According to this example embodiment, read/write circuit 220 reads and writes data to memory 210 in response to requests received from external devices such as a memory I/O circuit in a microprocessor system. Circuit 230 is adapted, according to one example embodiment, to perform the functions described above with respect to FIG. 1 and/or the alternate embodiments also set forth herein. According to one example embodiment as illustrated, the refresh circuit may be contained within the NAND device 200. According to another example embodiment, the refresh operation may be controlled by an external device such as a microprocessor.

Referring now to FIG. 3, there is illustrated an electronic system or device 300 that uses the flash memory 210 described in FIG. 2. According to one embodiment, system or device 300 includes a processing unit 310 and flash memory 210 to store data or computer instructions. In one embodiment, processing unit 310 may access flash memory 210, for example directly or using a memory access circuit, to store or retrieve data. Alternatively, processing unit 310 may retrieve a computer program from memory 210 and in turn transfer it, for example, to a random access memory that may be on board or external to the processing unit 310. System or device 300 may be, for example, a programmable microprocessor-based system such as a personal computer or any other programmable device including portable or hand held devices such as notebook computers, personal digital assistants, mobile telephone systems, or the like.

As described above, a NAND SSD may refresh data that needs refreshing without consuming the write cycles or the power needed if it were to refresh in its entirety on every power up. Further, the inventive subject matter enables NAND SSDs to meet unrecoverable data loss specifications, even in the face of long power off periods, without extra restriction on the write/erase cycles.

In the claims:

1. Apparatus comprising:
a NAND memory device including a plurality of NAND memory locations each including a plurality of cells holding at least one charge used to represent one or more data bits of a page of data stored in the memory device;
at least one memory refresh component active at least in part upon initialization or start up of the NAND memory device to:
read one or more of the NAND memory locations storing data in the page stored in the memory device; and
determine the number of data bits that are no longer reliable and, if more than a threshold number of bits are no longer reliable, refreshing the respective memory location by re-writing all or part of the page containing the data bits using the same location or rewriting all or part of the page to a new location in the flash memory.

2. Apparatus according to claim 1 wherein the refresh component is a circuit and/or programmed computer.

3. Apparatus according to claim 1 further wherein the threshold number of bits is equal to a number less than or equal to the maximum number of bits that can be in error before error correction for the memory location is no longer effective.

4. A method comprising:
upon initialization or start up of a flash memory having NAND memory locations,
a) read one or more NAND pages stored in one or more groups of memory locations that include error correction information;
b) determine the number of data bits of a location that are no longer reliable; and
c) if more than a threshold number of bits are no longer reliable refreshing the respective memory location by re-writing all or part of the page containing the data bits in the same location or re-writing all or part of the page to a new location in the flash memory.

5. A method according to claim 4 further including setting the threshold number of bits to a number less than or equal to the maximum number of bits that can be in error before error correction for the memory location is no longer effective.

6. Apparatus comprising:
an electronic system including a microprocessor and at least one NAND memory device;
the NAND memory device including:
a plurality of NAND memory locations each including a plurality of cells holding at least one charge used to represent one or more data bits of a page of data stored in the memory device;
at least one memory refresh component active at least in part upon initialization or start up of the NAND memory device to:
read one or more of the NAND memory locations storing data in the page stored in the memory device; and
determine the number of data bits of that are no longer reliable and, if more than a threshold number of bits are no longer reliable, refreshing the respective memory location by re-writing all or part of the page containing the data bits using the same location or rewriting all or part of the page to a new location in the flash memory.

7. Apparatus according to claim 6 wherein the refresh component is a circuit and/or programmed computer.

8. Apparatus according to claim 1 wherein the pages are re-written during at least a portion of the time that the memory device is idle.

9. A method according to claim 4 wherein the pages are re-written during at least a portion of the time the memory is idle.
